(19) United States
(12) Patent Application Publication
(10) Pub. No.: US 2024/0156119 A1
(43) Pub. Date: May 16, 2024

(54) NON-DAIRY FERMENTED FOOD PRODUCT

(71) Applicant: Oatly AB, MALMÖ (SE)

(72) Inventors: Ksenia Purekhovskaya, MALMÖ (SE); Karen Burgos, MALMÖ (SE); Kerstin Holmgren, MALMÖ (SE)

(21) Appl. No.: 18/549,898

(22) PCT Filed: Mar. 9, 2021
(86) PCT No.: PCT/EP2021/055934

§ 371 Date: Sep. 8, 2023

(51) Int. Cl. A23C 11/10; A23L 7/104

(52) U.S. Cl. CPC A23C 11/10; A23L 7/104

(57) ABSTRACT

A non-dairy fermented food product has an oat derived material having dry matter in an amount of 5-20% by weight of the food product, at least one fat present in an amount of 15% by weight or below of the food product, at least one vegetable protein present in an amount of 6% by weight or below of the food product, and at least one starch present in an amount of 1-7% by weight of the food product.

### TECHNICAL FIELD OF THE INVENTION

The present invention relates to a non-dairy fermented food product and to a method for the preparation of such a non-dairy fermented food product.

### BACKGROUND

Yoghurt is a well-known food product prepared by bacterial fermentation of milk. Milk from cow is most commonly used to make yoghurt. The bacteria used to make yoghurts are known as yogurt cultures. Fermentation of sugars in the milk by these bacteria produces different products such as lactic acid, which acts on milk protein to give yoghurt its texture and characteristic flavor. There is a growing population which refrain from consumption of dairy products as well from meat products, for example for health reasons, religious reasons, and sustainability reasons. There is a growing trend, to choose products for consumption in the daily life which contribute to a positive climate impact. This may mean excluding or at least reducing intake of dairy containing products as well as meat products. The population consuming only vegetables, vegetarians, and vegans, is growing and the interest for such products is expected to grow.

Plant-based alternatives to yogurts are available on the market and may be made from nuts such as almonds, cashews, and coconut, and cereals such as oats. The plant-based alternatives to yoghurts as well as the dairy-based yogurts may contain live yoghurt cultures.

Even though there are non-dairy yoghurt like products available on the market, there is a need and demand for improved alternatives having desirable texture and taste to suit the consumer. Prior art non-dairy yoghurt like products may have a sandy or powdery mouthfeel, sticky texture and undesirable off flavors such as bitterness. With higher requirements on taste and texture there is a continued need for new products which are appealable to the growing consumer population as well as providing health effects and are sustainable from an environmental perspective. It is a further need to be able to provide non-dairy yoghurt like products suitable for preparation and sometimes also cooking.

### SUMMARY OF THE INVENTION

In the light of the above, it is an object of the present inventive concept to provide a non-dairy yoghurt like product, wherein one or more of the above-mentioned disadvantages of the prior art are addressed.

According to a first aspect of the present inventive concept there is provided a non-dairy fermented food product comprising; an oat derived material comprising dry matter in an amount of 5-20% by weight of the food product; at least one fat present in an amount of 15% by weight or below of the food product; at least one vegetable protein present in an amount of 6% by weight or below of the food product; at least one starch present in an amount of 1-7% by weight of the food product. The combination of ingredients or features provides a non-dairy fermented food product such as a plant-based yoghurt having an improved texture and taste. It has been shown that previous off-flavors of non-dairy fermented food products have been reduced.

According to a second aspect of the present inventive concept, there is provided a method for manufacturing non-dairy fermented food product, the method comprising: providing a mixture comprising oat derived material, vegetable fat, vegetable protein, and starch; heat treating the mixture; and fermenting the mixture.

According to a third aspect of the present inventive concept there is provided a non-dairy fermented food product obtainable by the method according to the second aspect.

Features from the first aspect may be relevant also for the second or third aspects, and vice versa.

### DETAILED DESCRIPTION

The present invention will now be described more fully hereinafter. This invention may, however, be embodied in many different forms and should not be construed as limited to the embodiments set forth herein; rather, these embodiments are provided for thoroughness and completeness, and for fully convey the scope of the invention to a skilled person. Although individual features may be included in different embodiments, these may possibly be combined in other ways, and the inclusion in different embodiments does not imply that a combination of features is not feasible. In addition, singular references do not exclude a plurality. In the context of the present invention, the terms “a”, “an” does not preclude a plurality.

The present inventive concepts are, at least in part, based on unexpected realisations that non-dairy fermented food products with desirable properties, including e.g. having improved texture and reduced off flavor, may be provided having a content of oat derived material and further ingredients comprising vegetable protein, fat and starch.

According to a first aspect of the present inventive concept there is provided a non-dairy fermented food product comprising; an oat derived material comprising dry matter in an amount of 5-20% by weight, such as 7-18% by weight, e.g. 10-12.5%, by weight of the food product; at least one fat present in an amount of 15% by weight or below of the food product; at least one vegetable protein present in an amount of 6% by weight or below of the food product; at least one starch present in an amount of 1-7% by weight of the food product. The combination of ingredients or features provides a non-dairy fermented food product such as a plant-based yoghurt having an improved texture and taste. It has been shown that previous off-flavors of the non-dairy fermented food product have been reduced.

The oat derived material may, for example, be provided in dry form during manufacturing of the non-dairy fermented food product. Further, the oat derived material may be provided as a liquid, e.g. syrup, or aqueous oat derived material during manufacturing of the non-dairy fermented food product. Thus, the oat derived material may be a liquid oat derived material. The oat derived material may be an oat drink, for example a liquid product sometimes referred to as an oat milk. For the purpose of improving understanding, the non-dairy fermented food product may be obtained using a liquid or aqueous oat derived material comprising, for example, 1-20% by weight of dry matter, such as 5-15% by weight, e.g. 10-15%, such as 13 or 14%.

Furthermore, said oat derived material may comprise 5-15%, by dry weight, protein, e.g. 6-14%, 7-13%, 6-12%, by dry weight protein, and 3-10%, by dry weight, fat, e.g. 4-9%, 5-8%, by dry weight, fat. The oat derived material may also comprise carbohydrates and/or starch. It is realized that the components of the oat derived material such as fat and protein are in addition to the components as added to the non-dairy fermented food product during manufacturing.

The oat derived material may be provided in an amount of 5-20% dry matter by weight, such as 7-18% dry matter by weight, e.g. 10-12.5% dry matter by weight, such as 10, 11 or 12% dry matter by weight, of the non-dairy fermented food product which allows for introduction of beneficial properties to the non-dairy fermented food product. The oat derived material may provide for example flavor, color, texture, and structure to the non-dairy fermented food product, as well as, for example, providing a source of proteins, vegetable fat and fibers. For example, the oat derived material may provide β-glucans to non-dairy fermented food product, which in combination with other ingredients of the non-dairy fermented food product may provide health-beneficial properties, which may include assisting in lowering cholesterol levels and blood sugar levels.

The oat derived material may be described as obtained from treatment of oats with suitable enzymes such as amylase. For example, α- and/or β-amylase may be used. Thereby, the oat derived material may comprise one, more or all of monosaccharides, disaccharides, for example, maltose, oligosaccharides, and/or fiber, for example β-glucans. The oat derived material may further comprise proteins and fat from the oats. All or part of unreacted or partly reacted starch and fibers from the oats may be removed or reduced in content in the treatment of the oats or prior to the addition of the oat-base to the non-dairy fermented food product.

Thus, the oat derived material may comprise components selected from the group consisting of fat, saturated fat, monounsaturated fat, polyunsaturated fat, carbohydrates, sugars, preferably maltose, fiber, protein, and beta glucan, and combinations thereof. It is realized that the components of the oat derived material such as fat and protein are in addition to the components as added to the non-dairy fermented food product during manufacturing.

The oat derived material may be obtained from treatment of oats comprising treatment with an enzyme such as amylase, for example as has been described in patent No. EP 1 383 396 B1.

The at least one fat may be present in an amount of 15% by weight or below of the non-dairy fermented food product such as present in an amount of 0.5-15% by weight of the non-dairy fermented food product, such as 1-10% or 2-5% by weight of the non-dairy fermented food product e.g. 2, 3, 4 or 5% by weight the non-dairy fermented food product or 10-15% by weight such as 11, 12, 13 or 14% by weight of the non-dairy fermented food product. The at least one vegetable fat present in the non-dairy fermented food product may be selected from any vegetable oil or vegetable fat and may be both liquid and solid. For instance the vegetable oil may be chosen from rape seed oil, maize oil, coconut oil, sunflower oil and oat oil, and a combination of any of the before mentioned vegetable oils.

The at least one vegetable protein may present in an amount of 6% by weight or below of the food product such as 0.5-5% by weight, e.g. 1, 2, 3, or 4 or 5% by weight of the non-dairy fermented food product.

The at least one vegetable protein present in the non-dairy fermented food product may be selected from a non-exhaustive list consisting of pea protein, potato protein, oat protein, faba bean protein, chickpea protein, lentil protein, chia protein, hemp protein, lupin protein, rapeseed protein, pumpkin protein, amaranth protein, mung bean protein, tomato protein, mushroom protein, and combinations thereof. In an embodiment said at least one vegetable protein is oat protein or said at least one protein is an oat protein in combination with another protein.

Said non-dairy fermented food product may comprise for instance at least two proteins. As an example, the vegetable protein present in said non-dairy fermented food product may comprise an oat protein and a protein selected from a list consisting of pea protein, potato protein, oat protein, faba bean protein, chickpea protein, lentil protein, chia protein, hemp protein, lupin protein, rapeseed protein, pumpkin protein, amaranth protein, mung bean protein, tomato protein, mushroom protein.

As a further example, the vegetable protein present in said non-dairy fermented food product may comprise a potato protein and a protein selected from a list consisting of pea protein, oat protein, faba bean protein, chickpea protein, lentil protein, chia protein, hemp protein, lupin protein, rapeseed protein, pumpkin protein, amaranth protein, mung bean protein, tomato protein, mushroom protein, wherein the amount of said potato protein to said protein selected from a list consisting of pea protein, oat protein, faba bean protein, chickpea protein, lentil protein, chia protein, hemp protein, lupin protein, rapeseed protein, pumpkin protein, amaranth protein, mung bean protein, tomato protein, mushroom protein is below 1:1. Thus, when potato protein is present as one of two or more proteins the amount of the two or more proteins is more than 50% by weight in relation to the potato protein. In particular, when potato protein is present as one of two or more proteins, the amount of the two or more proteins together with any protein provided with the oat-derived material, is more than 50% by weight in relation to the potato protein. It has been shown that e.g. the oat protein is beneficial for reducing the off flavor of potato protein. By increasing the amount of the two or more proteins above 50% compared to amount of potato protein in the non-dairy fermented food product, the off flavor of the potato protein is reduced. When a potato protein is used together with an oat protein, the amount of oat protein is above 50% compared to potato protein. The amount of oat protein includes both added oat protein and protein originating from the oat-derived material, which as discussed above also includes fat, protein, and starch.

The at least one protein may be added to the non-dairy fermented food product as an isolated protein or a protein containing fraction such as a protein containing flour or powder, preferably very fine protein containing powder of a small particle size such as approximately <150 μm, or <90 μm, or any other type of fine protein containing product with a similar particle size. The protein containing powder may comprise a certain proportion of protein for instance 10-50% by weight of the flour, e.g. 15-40%, or 15-30%, or 15-25% such 16, 17, 18, 19, 20, 21, 22, 23, 24 or 25% by weight of the powder.

The at least one starch may be present in an amount of approximately 1-7% by weight of the food product such as 2-6% by weight, e.g. approximately 3, 4 or 5% by weight of the non-dairy fermented food product. The non-dairy fermented food product may comprise at least one starch which is selected from native starch and modified starch, and combinations thereof. The non-dairy fermented food product may comprise two modified starches. Modified starches, such as modified potato starches or cereal starches, may have improved functional properties compared to native starches.

Modified starches can be prepared with desirable properties and degree of substitution by critically selecting a suitable modifying agent, suitable reaction conditions, and a native starch source. The challenges in the field of starch modification include the development and use of modification methods that are friendly to the environment and safe for the consumer. The starch may be present as a native or natural starch as is available from many different sources such as corn, potato, maize, rice, quinoa, tapioca, and cereals such as wheat, oat, rye, and barley. Any other starch source not mentioned here may naturally be used in the concept of the present invention.

The non-dairy fermented food product may further comprise calcium, preferably in form of tri-calcium phosphate, calcium carbonate, calcium citrate or a combination thereof. The calcium may also be present in mono- and dicalcium phosphate or any other form. The amount of calcium present may be present in the non-dairy fermented food product in the range 0.1-0.5 such as 0.2-0.4% by weight. Put in another way, a target is 120 mg Ca per 100 g non-dairy fermented food product.

The non-dairy fermented food product may further comprise one or more of vitamins, minerals, stabilizers, fiber, sugar, and lactic acid bacteria.

One or more stabilizers as used in the non-dairy fermented food product may comprise guar gum. The at least one stabilizer may be selected from guar gum, locust bean gum, pectin, and additional and/or similar stabilizers, and combinations thereof.

The non-dairy fermented food product may be a plant-based yoghurt like product. The fat content may be varied leading to either a high-fat content non-dairy fermented food product or a low-fat content non-dairy fermented food product. A high-fat content non-dairy fermented product may resemble a Greek style dairy yoghurt having high fat content.

The non-dairy fermented food product may alternatively be described as a plant-based, a vegan, a non-dairy and/or a vegetarian fermented food product. The non-dairy fermented food product may be totally free from animal ingredients. However, the non-dairy fermented food product may contain additives derived from animal sources, and still be according to embodiments described herein, although not preferred.

In an embodiment of the invention, there is provided a non-dairy fermented food product comprising;
an oat derived material comprising dry matter in an amount of 10-12.5% by weight of the food product;
at least one fat present in an amount of 1-10% by weight of the food product;
at least one vegetable protein present in an amount of 0.1-5% by weight of the food product;
at least one starch present in an amount of 1-5% by weight of the food product.

According to a second aspect of the present inventive concept, there is provided a method for manufacturing non-dairy fermented food product, the method comprising: providing a mixture comprising oat derived material, vegetable fat, vegetable protein, and starch; heat treating the mixture; and fermenting the mixture.

The heat treating in said method for manufacturing of non-dairy fermented food product is an ultra-high temperature (UHT) treatment at approximately 140° C., optionally followed by homogenization, which may be both a down-stream and an up-stream homogenization. It is realized that the temperature may be adapted to suit the specific equipment at hand to optimize the process conditions.

The method for manufacturing of non-dairy fermented food product may further comprise cooling of the mixture to below 42° C., e.g. below 41 or 40° C., prior to addition of lactic acid bacteria for fermenting the mixture. The method for manufacturing of non-dairy fermented food product may further comprise subjecting the mixture to smoothing.

The lactic acid bacteria as used for the fermentation as described above may be chosen from one or more of the following: Lactobacillus bulgaricus; Lactobacillus acidophilus; Lactobacillus lactis; Lactobacillus casei; Lactobacillus brevis; Lactobacillus paracasei; Lactobacillus plantarum; Lactobacillus rhamnosus; Lactobacillus sakei; Lactobacillus spicheri; Lactobacillus helveticus; Streptococcus thermophilus; Pediococcus pentosaeceus; Pediococcus acidilactici; Bifidobacterium lactis; Bifidobacterium animalis; Lactococcus lactis; Leuconostoc mesentorides; Lactococcus diacetyllactis; Lactococcus cremoris; and Weisella spp. A combination of any of the mentioned lactic acid bacteria may be used for the fermentation of the food product during the method for manufacturing. Such lactic acid bacteria in the non-dairy fermented food product may provide health benefits to the consumer of the final non-dairy fermented food product.

The method for manufacturing of non-dairy fermented food product may further comprise providing a mixture comprising; heating the oat derived material to 4-60° C., such as 10-40, for instance 20-40, e.g. 30-40; adding the vegetable protein to the heated oat derived material and mixing to provide a mixture; adding starch and optionally dry ingredients to the mixture, adding optionally calcium to the mixture; and adding the vegetable fat, thereby providing the mixture comprising oat derived material, vegetable fat, vegetable protein, and starch.

The addition of calcium is preferably added as the last added component of the dry ingredients, in case a stabilizer such as pectin is used, since undesirable boundaries of bivalent calcium ions and pectin can appear. Pectin should at first come into contact with proteins to create a matrix and thereafter the calcium may be added.

The method for manufacturing of non-dairy fermented food product may further comprise pasteurization after fermenting the mixture, optionally followed by addition of acids.

According to a third aspect of the present inventive concept there is provided a non-dairy fermented food product obtainable by the method according to the second aspect.

The method as described above is suitable for manufacturing of the non-dairy fermented food product as described herein.

Different non-dairy yoghurt like products as prepared will now be described.

### EXAMPLES

### Example 1—Method of Manufacturing Non-Dairy Cup Yoghurt

Heat 92% by weight oat base (containing 13% by weight dry matter and 1.1% oat protein) to 40° C. Add 0.35% by weight potato protein fraction (containing 90% protein) and optionally 2% by weight of an oat protein composition comprising about 19% by weight oat protein (a very fine powder of a particle size <90 μm (90%)) or of an oat protein composition comprising about 20% by weight oat protein (a very fine powder of a particle size of <150 μm (90%)), depending of which type of non-dairy fermented food product that is prepared, perform mixing during 30 min. Add 4.50% by weight modified potato starch, 0.5% by weight pectin, and thereafter 0.34% by weight Ca source (0.14% by weight tri-calcium phosphate and 0.2% by weight calcium carbonate) is added to the mixture. Calcium is added last of the dry ingredient in order to prevent boundaries with positive ions/pectin. Mixing for 30 minutes. Thereafter, 2.3% by weight rape seed oil is added. The oil is added last in order to avoid foam formation. Thereafter the mixture is proceeded to heating stage.

The mixture is preheated to approximately 80° C. (required step to all UHT) and thereafter subjected to UHT heat treatment at approximately 140° C. via direct stream injection (DSI) and thereafter flash cooling to appr. 80° C. and downstream homogenization 250/50.

The mixture is subjected to cooling to fermentation temperature which is approximately 40° C. and thereafter the mixture is subjected to fermentation after addition of bacterial starter culture 1 (Pedicoccus pentosaseus, Lactobacillus paracasie, Lactobacillus acidophilus); starter culture 2 (Lactobacillus paracasie, Lactobacillus acidophilus, Lactobacillus plantarum), starter culture 3 (Streptococcus thermophilus, Lactobacillus delbruekii spp bulgaricus, Lactobacillus acidophilus, Lactobacillus plantarum, Bifidobacterium lactis) and starter culture 4 (Streptococcus thermophilus, Lactobacillus delbruekii spp bulgaricus, Lactobacillus acidophilus, Bifidobacterium lactis) for appr. 8-10 hours. Thereafter the mixture is cooled to approximately 20° C. and optionally subjected to smoothing. Smoothing can be done through 3-4 different types of equipment and can take place either before cooling or after. Finally the mixture is filled into to cups at 18-20° C. and subjected to rapid cooling via cooling tunnel/cooling cells and finally stored cold.

The oat base as used in the experiment contains typically per 100 g of oat base product, dry weight, 10.5 g protein, 8.4 dietary fiber, 4 g beta glucan, 5.3 g fat, 42 g carbohydrate.

The above procedure was used to prepare the following non-dairy fermented products as well with slightly different components as shown in the table.

TABLE 1

| | | | | | | Greek | |
|---|---|---|---|---|---|---|---|
| | cup | cup | cup | cup | cup | Style | cup |
| Components | % | | | | | | |
| Oat base conv. | 91.56 | 91.56 | 92.01 | 92.31 | 89.51 | 83.31 | 92.31 |
| (13% dry | | | | | | | |
| matter) | | | | | | | |
| 1.1% oat | | | | | | | |
| protein. | | | | | | | |
| Potato protein | 0.35 | 0.35 | 0.35 | 0.35 | 0.35 | 1.55 | 0.35 |
| (90% content) | | | | | | | |
| (oat protein | | | | 2 | 2 | | |
| powder) 20% | | | | | | | |
| protein | | | | | | | |
| (oat protein | | | | | | 2 | 2 |
| powder) 19% | | | | | | | |
| protein | | | | | | | |
| Oil (rapeseed) | 2.3 | 2.3 | 2.3 | 2.3 | 2.3 | 9.3 | 2.3 |
| Mod. potato | 1.5 | | | | | | |
| starch | | | | | | | |
| Modified | | 2.25 | 2.25 | 1.1 | 2.25 | 1.5 | 1.1 |
| potato starch | | | | | | | |
| Modified | 3 | 2.25 | 2.25 | 1.1 | 2.25 | 1.5 | 1.1 |
| potato starch) | | | | | | | |
| Pectin | | | 0.5 | 0.5 | | 0.5 | 0.5 |
| Oat fiber | 0.45 | 0.45 | | | | | |
| Sucrose | 0.5 | 0.5 | | | 0.5 | | |
| Citrus fiber | | | | | 0.5 | | |
| Tricalcium | 0.14 | 0.14 | 0.14 | 0.14 | 0.14 | 0.14 | 0.14 |
| phosphate | | | | | | | |
| (calcium | | | | | | | |
| source) | | | | | | | |
| Calcium | 0.2 | 0.2 | 0.2 | 0.2 | 0.2 | 0.2 | 0.2 |
| carbonate | | | | | | | |
| (calcium | | | | | | | |
| source) | | | | | | | |
| Total | 100 | 100 | 100 | 100 | 100 | 100 | 100 |

The obtained non-dairy fermented food products as prepared according to Table 1 had beneficial perception when consumed. The texture has been improved and previous off-taste of potato protein has been reduced. To be able to cover the taste of potato protein of the final non-dairy fermented food product is surprising and appealable to the final consumer. The potato protein may lead to undesirable off flavors even at low levels and the oat protein covers that taste. The oat protein powder, in contrary to oat flour, together with the additional ingredients leads to a smooth and creamy texture without sandiness and chalkiness.

1. A non-dairy fermented food product comprising:
an oat derived material comprising dry matter in an amount of 5-20% by weight of the food product;
at least one fat present in an amount of 15% by weight or below of the food product;
at least one vegetable protein present in an amount of 6% by weight or below of the food product;
at least one starch present in an amount of 1-7% by weight of the food product.

2. A non-dairy fermented food product according to claim 1, wherein said at least one vegetable protein is selected from a list consisting of pea protein, potato protein, oat protein, faba bean protein, chickpea protein, lentil protein, chia protein, hemp protein, lupin protein, rapeseed protein, pumpkin protein, amaranth protein, mung bean protein, tomato protein, mushroom protein, and combinations thereof.

3. The non-dairy fermented food product according to claim 1, wherein at least one vegetable protein is oat protein.

4. The non-dairy fermented food product according to claim 1, wherein said non-dairy fermented food product comprises at least two proteins.

5. The non-dairy fermented food product according to claim 4, wherein said non-dairy fermented food product comprises an oat protein and a protein selected from a list consisting of pea protein, potato protein, oat protein, faba bean protein, chickpea protein, lentil protein, chia protein, hemp protein, lupin protein, rapeseed protein, pumpkin protein, amaranth protein, mung bean protein, tomato protein, mushroom protein, and combinations thereof.

6. The non-dairy fermented food product according to claim 1, wherein said oat derived material comprises 5-15% protein by dry weight of the oat derived material.

7. The non-dairy fermented food product according to claim 6, wherein said oat derived material comprises 5-15% protein by weight and fat 3-10% fat by dry weight of the oat derived material.

8. The non-dairy fermented food product according to claim 1, wherein said at least one starch is selected from native starch and modified starch, and combinations thereof.

9. The non-dairy fermented food product according to claim 1, further comprising calcium, preferably in form of tri-calcium phosphate, calcium carbonate, calcium citrate or a combination thereof.

10. The non-dairy fermented food product according to claim 1, further comprising one or more of vitamins, minerals, stabilizer, fiber, sugar, and lactic acid bacteria.

11. The non-dairy fermented food product according to claim 1, wherein said non-dairy fermented food product is a plant-based yoghurt like product.

12. A method for manufacturing a non-dairy fermented food product, the method comprising:
providing a mixture comprising oat derived material, vegetable fat, vegetable protein, and starch;
heat treating the mixture; and
fermenting the mixture.

13. The method for manufacturing a non-dairy fermented food product according to claim 12, wherein the heat treating is an ultra-high temperature treatment at approximately 140° C.

14. The method for manufacturing a non-dairy fermented food product according to claim 12, further comprising cooling of the mixture to below approximately 42° C. prior to addition of lactic acid bacteria for fermenting the mixture.

15. The method for manufacturing a non-dairy fermented food product according to claim 12.

16. The method for manufacturing a non-dairy fermented food product according to claim 12, wherein the providing a mixture comprises;
heating the oat derived material to 4 to 60° C.;
adding the vegetable protein to the heated oat derived material and mixing to provide a first mixture;
adding starch to the first mixture; and
adding the vegetable fat, thereby providing the mixture comprising oat derived material, vegetable fat, vegetable protein, and starch.

17. The method for manufacturing a non-dairy fermented food product according to claim 12, wherein the method further comprises pasteurization after fermenting the mixture.

18. (canceled)

19. (canceled)

20. The method for manufacturing a non-dairy fermented food product according to claim 13, wherein the heat treating is followed by homogenization.

21. The method for manufacturing a non-dairy fermented food product according to claim 15, wherein the method further comprises subjecting the mixture to smoothing.

22. The method for manufacturing a non-dairy fermented food product according to claim 16, wherein the method further comprises adding dry ingredients or calcium to the first mixture.

23. The method for manufacturing a non-dairy fermented food product according to claim 17, wherein the method further comprises addition of acids.
